(19) United States
(12) Patent Application Publication
(10) Pub. No.: US 2014/0310044 A1
(43) Pub. Date: Oct. 16, 2014

(54) Transmitting an Electronic Message to Calendar Event Invitees

(71) Applicant: GO DADDY OPERATING COMAPNY, LLC, Scottsdale, AZ (US)

(72) Inventors: Jason Meltzer, Chandler, AZ (US); Christopher Thompson, Castle Rock, CO (US)

(73) Assignee: Go Daddy Operating comapny, LLC, Scottsdale, AZ (US)

(21) Appl. No.: 13/863,949

(22) Filed: Apr. 16, 2013

(51) Int. Cl. G06Q 10/10

(52) U.S. Cl. CPC G06Q 10/1095
USPC 705/7.19

(57) ABSTRACT

Systems and method of the present invention provide for one or more server computers configured to identify, within a database, an invitee the invitee's attendance status for an electronic calendar event; generate a control panel comprising a selectable list of a plurality of attendance statuses, including the attendance status of the at least one invitee; transmit the control panel to a client computer; receive a selection of the attendance status of the at least one invitee and a message content for the electronic message; and transmit the electronic message to the at least one invitee.

This patent application is related to U.S. patent application Ser. No. ______ entitled: “GENERATING AND DISPLAYING A CALENDAR EVENT RECURRENCE PREVIEW” concurrently filed herewith and also assigned to Go Daddy Operating Company, LLC.

### FIELD OF THE INVENTION

The present inventions generally relate to electronic calendars and, more specifically, systems and methods for transmitting an electronic message to calendar event invitees and for generating and displaying a preview of a recurring calendar event.

### SUMMARY OF THE INVENTION

An example embodiment of a method of transmitting an electronic message according to an attendance status of at least one invitee to a calendar event may comprise the steps of one or more server computers: identifying, within a database, at least one invitee associated in the database with the calendar event and the attendance status of the at least one invitee; generating a control panel comprising a presentation display of a plurality of attendance statuses, including the attendance status of the at least one invitee, the list being configured for a user to select the attendance status of the at least one invitee from the list; transmitting the control panel to a client computer; receiving a selection, from the list, of the attendance status of the at least one invitee and a message content for the electronic message; and transmitting the electronic message, comprising the electronic message content, to the at least one invitee.

An example embodiment of a system for transmitting an electronic message according to an attendance status of at least one invitee to a calendar event may comprise one or more server computers communicatively coupled to a network and configured to: identify, within the database, at least one invitee associated in the database with the calendar event and the attendance status of the at least one invitee; generate a control panel comprising a presentation display of a plurality of attendance statuses, including the attendance status of the at least one invitee, the list being configured for a user to select the attendance status of the at least one invitee from the list; transmit the control panel to a client computer; receive a selection, from the list, of the attendance status of the at least one invitee and a message content for the electronic message; and transmit the electronic message, comprising the electronic message content, to the at least one invitee.

An example embodiment of a method of generating and displaying a preview of a recurring calendar event may comprise the steps of one or more server computers: receiving a start date and a recurrence interval for an electronic calendar event; generating a recurrence preview calendar comprising a graphical representation of a plurality of dates arranged to represent days and weeks within at least one month; highlighting, within the recurrence preview calendar, the start date and at least one of the plurality of dates after the start date occurring at the recurrence interval; and transmitting the recurrence preview calendar to a client computer.

An example embodiment of a system for generating and displaying a preview of a recurring calendar event may comprise one or more server computers communicatively coupled to a network and configured to: receive a start date and a recurrence interval for an electronic calendar event; generate a recurrence preview calendar comprising a graphical representation of a plurality of dates arranged to represent days and weeks within at least one month; highlight, within the recurrence preview calendar, the start date and at least one of the plurality of dates after the start date occurring at the recurrence interval; and transmit the recurrence preview calendar to a client computer.

The above features and advantages of the present inventions will be better understood from the following detailed description taken in conjunction with the accompanying drawings.

### BRIEF DESCRIPTION OF THE DRAWINGS

FIG. 1 is a flow diagram illustrating a possible embodiment of a method for generating an electronic calendar, control panel and/or calendar event and transmitting the calendar, control panel and/or calendar event to a client computer for display.

FIG. 2 illustrates a possible embodiment of a system for transmitting an electronic message to calendar event invitees and generating and displaying a preview of a recurring calendar event.

FIG. 3 illustrates a more detailed possible embodiment of a system for transmitting an electronic message to calendar event invitees and generating and displaying a preview of a recurring calendar event.

FIG. 4 is an example interface illustrating a possible embodiment of a system and method for generating an electronic calendar, control panel and/or calendar event and transmitting the calendar, control panel and/or calendar event to a client computer for display.

FIG. 5 is a flow diagram illustrating a possible embodiment of a method for transmitting an electronic message to calendar event invitees.

FIG. 6 is an example interface illustrating a possible embodiment of a system and method for inviting one or more calendar event invitees to the calendar event.

FIG. 7 is an example interface illustrating a possible embodiment of a system and method for transmitting an electronic message to calendar event invitees.

FIG. 8 is a flow diagram illustrating a possible embodiment of a method for generating and displaying a preview of a recurring calendar event.

FIG. 9 is an example interface illustrating a possible embodiment of a system and method for generating and displaying a preview of a recurring calendar event.

FIG. 10 is an example interface illustrating a possible embodiment of a system and method for generating and displaying a preview of a recurring calendar event.

FIG. 11 is an example interface illustrating a possible embodiment of a system and method for generating and displaying a preview of a recurring calendar event.

FIG. 12 is an example interface illustrating a possible embodiment of a system and method for generating and displaying a preview of a recurring calendar event.

FIG. 13 is an example interface illustrating a possible embodiment of a system and method for generating and displaying a preview of a recurring calendar event.

FIG. 14 is an example interface illustrating a possible embodiment of a system and method for creating a reminder for an electronic calendar event.

FIG. 15 is an example interface illustrating a possible embodiment of a system and method for adding an attachment to an electronic calendar event.

### DETAILED DESCRIPTION

The present inventions will now be discussed in detail with regard to the attached drawing figures, which were briefly described above.

In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected or otherwise related webpages. The combination of all the websites and their corresponding webpages on the Internet is generally known as the World Wide Web (WWW) or simply the Web.

An electronic calendar is a software application that enables users to have electronic versions of commonly-used office tools, such as a calendar, appointment book, address book, contact list, and/or task manager. Electronic calendars have become a common and convenient way of keeping track of events, such as appointments, meetings, airplane flights, etc. They permit users to manage their calendar data (e.g., adding contact information, scheduling meetings, or blocking out vacation time) via an easily accessible and manipulatable user interface. Electronic calendars may run on—and be accessed by—virtually any electronic device including a desktop computer, laptop computer, hand held computer, personal digital assistant, and/or cellular or wireless phone. Most electronic calendars are either web-based or client-based.

Web-based electronic calendars operate via software residing on servers that are accessible via a client electronic device connected to the Internet. Examples of web-based electronic calendars include GODADDY.COM ONLINE GROUP CALENDAR, GOOGLE CALENDAR, YAHOO CALENDAR, and MICROSOFT WINDOWS LIVE CALENDAR. Such calendars may be accessed over the Internet by virtually any client. Client-based electronic calendars, on the other hand, operate via software residing on the client and generally may be accessed only via that client. Examples of client-based electronic calendars include MICROSOFT OUTLOOK.

Applicant has determined that presently-existing electronic calendars do not provide any means for a user to visualize a recurrence of a calendar event (e.g., a calendar event that repeats on every first Monday of the month for a year). For example, on some months, the first Monday may fall on the first of the month, on other months, the first Monday may fall on the seventh of that month. A calendar user may desire a means to visualize the dates that particular days of the month or year may fall on when scheduling an event with some frequency.

Additionally, Applicant has determined that once the event is scheduled, presently-existing electronic calendars do not provide any means for the organizer of the calendar event (or any of the potential attendees of the calendar event) to contact the potential attendees of the calendar event. Furthermore, presently-existing electronic calendars provide no way for the organizer of the event to send an electronic message to specific groups of potential attendees of the calendar event based on their attendance status. For example, an event organizer may want to send additional details or documents for a scheduled event to all invitees, or may want to send a follow up email only to those invitees who have not yet responded to the original calendar event invitation to determine if they are planning to attend.

Applicant has therefore determined that optimal systems and methods may comprise an electronic calendar software configured to generate a visual preview of all recurring dates for a recurring calendar event, prior to a user selecting a recurring calendar event date, thereby allowing a user to visualize the days of the week or month that a particular recurring date falls on. Applicant has further determined that optimal systems and methods may comprise an electronic calendar software configured to receive a selection of invitees to a calendar event by attendance status and send an electronic message comprising a second invitation to, or additional details about the calendar event, to the selected groups.

Methods and Systems for Generating and Displaying a Calendar Control Panel

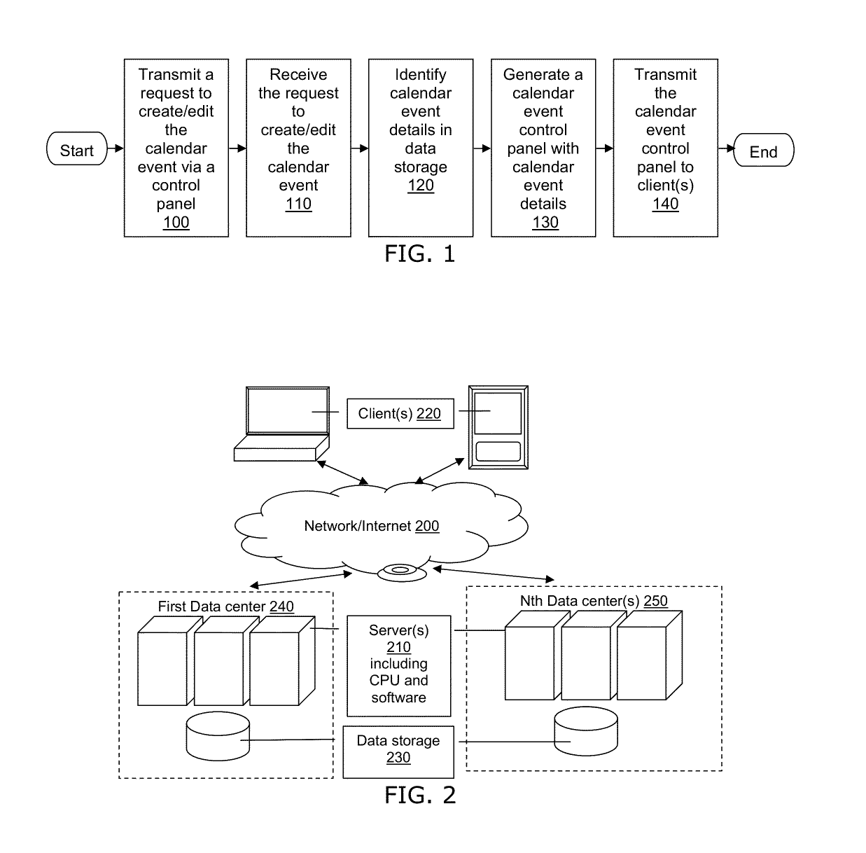

Several different methods may be used to provide and manage the disclosed inventions. In an example embodiment illustrated in FIG. 1, any combination of software modules running on one or more server computers, as described below, may be configured to: transmit a request to create and/or edit a calendar event via a control panel generated on a server, and transmitted to a client computer for display (Step 100); receive the request to create and/or edit the electronic calendar event (Step 110); identify, within data storage, the calendar event and/or any calendar event details associated with the calendar event (Step 120); generate a calendar event control panel comprising one or more user interface elements containing the details of the calendar event (Step 130); and transmit the calendar event control panel to one or more client computers (Step 140).

Several different environments may be used to accomplish the steps of embodiments disclosed herein. FIG. 2 demonstrates a streamlined example of such an environment and illustrates a non-limiting example of a system and/or structure that may be used to accomplish the methods and embodiments disclosed and described herein. Such methods may be performed by any central processing unit (CPU) in any computing system, such as a microprocessor running on at least one server 210 and/or client 220, and executing instructions stored (perhaps as scripts and/or software, possibly as software modules) in computer-readable media accessible to the CPU, such as a hard disk drive on server(s) 210 and/or client(s) 220.

The example embodiments herein place no limitations on whom or what may comprise users. Thus, as non-limiting examples, users may comprise any individual, entity, business, corporation, partnership, organization, governmental entity, and/or educational institution.

The example embodiments shown and described herein exist within the framework of a network 200 and should not limit possible network configuration or connectivity. Such a network 200 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

At least one server 210 and at least one client 220 may be communicatively coupled to the network 200 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The server(s) 210 and client(s) 220 (along with software modules and the data storage 230 disclosed herein) may be communicatively coupled to the network 200 and to each other in such a way as to allow the exchange of information required to accomplish the method steps disclosed herein, including, but not limited to receiving the information from a user interface on one or more clients 220, and one or more servers 210 receiving the information as transmitted by the client(s) 220.

The client(s) 220 may be any computer or program that provides services to other computers, programs, or users either in the same computer or over a computer network 200. As non-limiting examples, the client(s) 220 may be an application, communication, mail, database, proxy, fax, file, media, web, peer-to-peer, or standalone computer, cell phone, “smart” phone, personal digital assistant (PDA), etc. which may contain an operating system, a full file system, a plurality of other necessary utilities or applications or any combination thereof on the client 220. Non limiting example programming environments for client applications may include JavaScript/AJAX (client side automation), ASP, JSP, Ruby on Rails, Python's Django, PHP, HTML pages or rich media like Flash, Flex, Silverlight, any programming environments for mobile “apps,” or any combination thereof.

The client computer(s) 220 which may be operated by one or more users and may be used to connect to the network 200 to accomplish the illustrated embodiments may include, but are not limited to, a desktop computer, a laptop computer, a hand held computer, a terminal, a television, a television set top box, a cellular phone, a wireless phone, a wireless hand held device, a “smart” phone, an Internet access device, a rich client, thin client, or any other client functional with a client/server computing architecture. Client software may be used for authenticated remote access to one more hosting computers or servers, described below. These may be, but are not limited to being accessed by a remote desktop program and/or a web browser, as are known in the art.

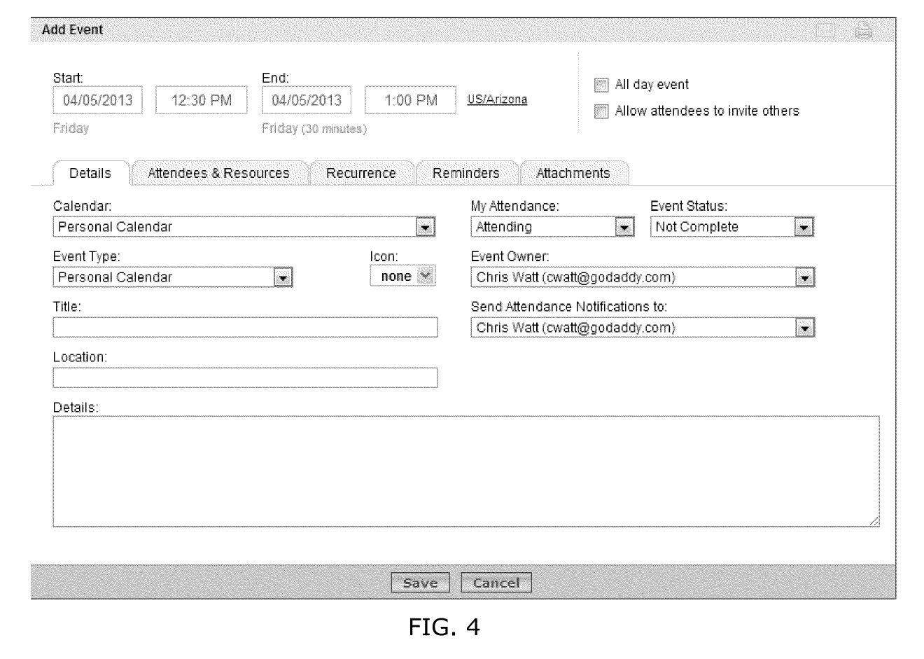

The user interface displayed on the client(s) 220 or the server(s) 210 may be any graphical, textual, scanned and/or auditory information a computer program presents to the user, and the control sequences such as keystrokes, movements of the computer mouse, selections with a touch screen, scanned information etc. used to control the program. Examples of such interfaces include any known or later developed combination of Graphical User Interfaces (GUI) or Web-based user interfaces as seen in and after FIG. 4, including Touch interfaces, Conversational Interface Agents, Live User Interfaces (LUI), Command line interfaces, Non-command user interfaces, Object-oriented User Interfaces (OOUI) or Voice user interfaces. Any information generated by the user, or any other information, may be accepted using any field, widget and/or control used in such interfaces, including but not limited to a text-box, text field, button, hyper-link, list, drop-down list, check-box, radio button, data grid, icon, graphical image, embedded link, etc.

The software modules used in the context of the current invention may be stored in the memory of—and run on—at least one server 210 and/or client 220. The software modules may comprise software and/or scripts containing instructions that, when executed by a microprocessor on a server 210 and/or client 220, cause the microprocessor to accomplish the purpose of the module or the methods disclosed herein.

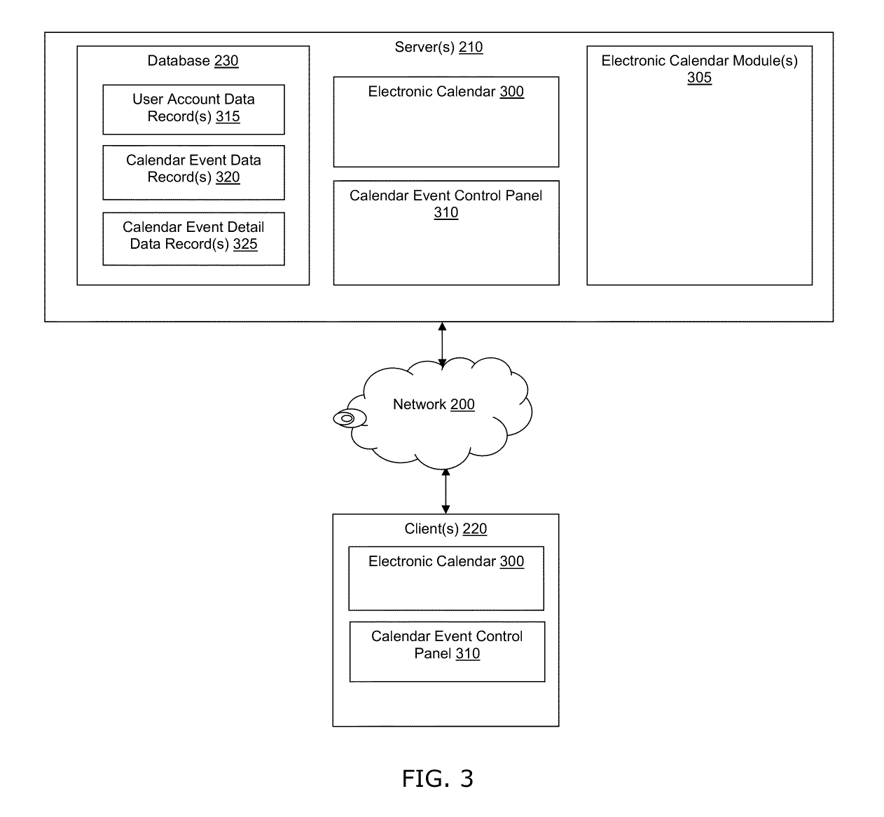

As a non-limiting example, the electronic calendar 300 may comprise a software application that enables a user to, among other things, have electronic access to commonly-used office tools, such as a calendar, appointment book, address book, contact list, and/or task manager. It may have the ability to display a calendar in a plurality of different formats (e.g., hourly, daily, weekly, monthly views, etc.). The electronic calendar 300 could be web-based, client-based, a stand-alone application, a component of a larger application, and/or any combination thereof. In the example embodiment illustrated in FIG. 3, the electronic calendar 300 resides on a server. The calendar may be a part of a desktop workspace application providing various other office functions, such as email functionality, online file storage fax capabilities. ONLINE GROUP CALENDAR, a part of GO DADDY's WORKSPACE online application, is a non-limiting example of such a desktop workspace software application.

The electronic calendar events (as well as any related calendar event details) may call for configured calendar data, perhaps in a standard or modified iCalendar, vCalendar, vCal, or any other specified format that may be compatible with the electronic calendar 300 or an API. iCalendar is a widely-accepted and used calendar data standard (see RFC 2445, which is incorporated herein by reference). It allows users to send meeting requests and tasks to other users, typically through email, but the standard is designed to be independent of the transport protocol. vCalendar was the precursor to, and is generally compatible with, iCalendar. vCal is an open source calendar data standard that can be exported to both the iCalendar or vCalendar formats. Once configured data is received, the event may be scheduled on the electronic calendar 300.

The configured calendar data may relate to the event's description, topic, objective, date, time, location, participants, subject matter, priority, relative importance, recurrence, resources required for a calendar event, and/or any combination thereof. The specified format for the configured calendar data may or may not require additional approval (e.g., acceptance of an invite) before the calendar event is docketed with the electronic calendar 300.

Any utilized API may comprise a software-to-software interface that specifies the protocol defining how independent computer programs interact or communicate with each other. The API may allow a series of function calls (requests for services). It may comprise an interface provided by the electronic calendar 300 to support function calls made of the electronic calendar 300 by other computer programs to schedule events. It also may comprise a collection of pre-configured building blocks allowing compatibility and/or extensibility with the electronic calendar 300. The API may comprise any API type known in the art or developed in the future including, but not limited to, request-style, Berkeley Sockets, Transport Layer Interface (TLI), Representational State Transfer (REST), SOAP, Remote Procedure Calls (RPC), Standard Query Language (SQL), file transfer, message delivery, and/or any combination thereof. Access to the API then may be governed by an access-protected URL that permits access only to properly-identified entities.

The server(s) utilized within the disclosed system 210 may comprise any computer or program that provides services to other computers, programs, or users either in the same computer or over a computer network 200. As non-limiting examples, the server 210 may comprise application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, a cloud hosting solution, a grid hosting solution, or any combination thereof). The server 210 may exist within a server cluster, as illustrated. These clusters may include a group of tightly coupled computers that work together so that in many respects they can be viewed as though they are a single computer. The components may be connected to each other through fast local area networks which may improve performance and/or availability over that provided by a single computer.

The server(s) 210 or software modules within the server(s) 210 may receive hypertext transfer protocol (HTTP) requests for files or other data stored on the server(s) 210 and may use server-side scripting languages such as ASP, PHP, CGI/Perl, proprietary scripting software/modules/components etc. to generate the files requested and respond with the generated files/pages to be displayed on the client(s) 220.

The server(s) 210 or software modules within the server(s) 210 may use query languages such as MSSQL or MySQL to retrieve the content from data storage 230. Server-side scripting languages such as ASP, PHP, CGI/Perl, proprietary scripting software/modules/components etc. may be used to process the retrieved data. The retrieved data may be analyzed in order to determine information recognized by the scripting language, information to be matched to those found in data storage, availability of requested information, comparisons to information displayed and input/selected from the user interface or any other content retrieval within the method steps disclosed herein.

The server 210 and/or client 220 may be communicatively coupled to data storage 230 to retrieve any information requested. The data storage 230 may be any computer components, devices, and/or recording media that may retain digital data used for computing for some interval of time. The storage may be capable of retaining stored content for any data requested, on a single machine or in a cluster of computers over the network 200, in separate memory areas of the same machine such as different hard drives, or in separate partitions within the same hard drive, such as a database partition.

Non-limiting examples of the data storage 230 may include, but are not limited to, a Network Area Storage, (“NAS”), which may be a self-contained file level computer data storage connected to and supplying a computer network with file-based data storage services. The storage subsystem may also be a Storage Area Network (“SAN”—an architecture to attach remote computer storage devices to servers in such a way that the devices appear as locally attached), an NAS-SAN hybrid, any other means of central/shared storage now known or later developed or any combination thereof.

Structurally, the data storage 230 may comprise any collection of data. As non-limiting examples, the data storage 230 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

As seen in FIG. 2, the software modules, server(s) 210 and/or data storage 230 may exist and/or be hosted in one or more data centers 240, 250. These data centers 240, 250 may provide hosting services for websites, services or software relating to stored information, or any related hosted website including, but not limited to hosting one or more computers or servers in a data center 240, 250 as well as providing the general infrastructure necessary to offer hosting services to Internet users including hardware, software, Internet web sites, hosting servers, and electronic communication means necessary to connect multiple computers and/or servers to the Internet or any other network 200.

As users access and/or input information, this information may be redirected and distributed between and among the data centers 240, 250 via commands from any combination of software modules hosted on the server(s) 210 and executed via processors on the server(s) 210. This information may then be accessed and manipulated by the combination of software modules or stored in the data storage 230 of any of a plurality of data centers 240, 250, either separate from or integrated into the one or more servers 210, so that the information is available to be searched and accessed by the user and/or any other components of any or all data centers 240, 250.

Any references to “software combination,” “combination of software,” “combination of software modules” etc. referred to herein may include any combination of software modules executed by a microprocessor on either the server 210 or client 220 computers. These software modules may also be used in combination with any other method steps, hardware and/or software structures disclosed herein. The servers 210 may be hosted in any data center 240, 250 operated by any hosting provider such as those disclosed herein and the servers 210 and clients 220 may be operated by any users disclosed herein.

In the interest of simplicity, FIG. 3 shows a consolidated environment for accomplishing the methods disclosed herein, where the disclosed software modules 300, 305, 310 and database 230 are all hosted on a single server computer 210 in a single data center 240. Other embodiments, however, may utilize a highly distributed environment wherein the disclosed software modules 300, 305, 310 and database 230 are each hosted on their own separate server 210 and communicatively coupled to one another via the network 200. Thus, any combination of the disclosed software may be hosted on any combination of server(s) 210 and communicatively coupled to the network 200.

As seen in FIG. 3, the server(s) 220 may host one or more electronic calendar software modules 300, 305, 310 running on the server(s) 210, the client(s) 220, or any combination thereof. The electronic calendar module(s) 305 may be configured to authenticate an electronic calendar user, generate the electronic calendar 300 (including any disclosed elements of the electronic calendar 300, such as the control panel 310) and transmit the generated electronic calendar for display on client(s) 220, possibly as part of a workspace-type software as described herein.

To authenticate the user, the electronic calendar module(s) 305 may be configured to receive the user's authentication information, such as a user name or password, from the client(s) 220. The electronic calendar 300 may then be configured to compare the received authentication information with data, possibly one or more electronic calendar 300 and/or workspace user account data records 315 in data storage 230. If the electronic calendar module(s) 305 confirm the existence of the user's authentication information within the data storage 230, the user may be authenticated and electronic calendar data associated with that user may be made available to the electronic calendar module(s) 305 for that user.

The server(s) 220 and/or the calendar software module(s) 305 may be configured to generate the electronic calendar 300 interface according to one or more stored preferences of the user. As a non-limiting example, the electronic calendar module(s) 305 may be configured to generate the calendar interface according to a current day, a current 5 day period, a current week, a current month or a current year. These “calendar views” may be generated by the electronic calendar module(s) 305 in such a way that the user may navigate between the selected view. For example, although a current day, week, month or year may be generated and displayed, the generated and displayed calendar view may also include user interface elements allowing the user to navigate between previous or future days, weeks, months, years, etc.

Likewise, the electronic calendar module(s) 305 may be configured to receive a selection from the user, via the generated calendar view, of a different preferred calendar view. On receipt of a selection of a different preferred calendar view, the electronic calendar module(s) 305 may be configured to generate the electronic calendar 300 using the selected calendar view and transmit the updated generated calendar view to the client(s) 220 for display.

In some embodiments, the user's preference for a particular calendar view may be stored in data storage 230, and the electronic calendar module(s) 305 may be configured to access the user's preference in data storage 230 and generate the electronic calendar 300 for display according to the user's preferred calendar view. In other embodiments, the electronic calendar module(s) 305 may be configured to identify and store the selected displayed calendar view when the user exits the electronic calendar 305 display.

The electronic calendar module(s) 305 may be configured to populate the displayed calendar view with one or more calendar events. As a non-limiting example, a “day view” generated and displayed by the electronic calendar module(s) 305 may display one or more “time slots” for each hour in the day. These time slots may be populated with a graphic or text indicating a scheduled calendar event during that time period. For example, the 9:00 AM time slot may be populated with a highlighted background and the text “9:00 am Staff Meeting.”

To accomplish this, the electronic calendar module(s) 305 may be configured, prior to generating the electronic calendar 300, to identify data for one or more calendar events stored in data storage 230 in association with the authenticated user. As non-limiting examples, data storage 230 may be configured to store, for each user, a user account data record 315 comprising a unique user identifier for the user. In some embodiments, the user account data record 315 may further comprise the user's contact information, possibly including any combination of an email address or a phone number for a “smart phone,” possibly configured to receive email for the email address, text messages, SMS messages, etc. In other embodiments, the contact information for the user may be stored in one or more contact information records joined to the user account data record 315, possibly via a foreign key.

Data storage 230 may be further configured, in this example, to store one or more calendar event data records 320, each comprising a unique calendar event identifier for a calendar event. Each calendar event data record 320 may also be joined, possibly via a foreign key in the data records, to one or more user account data records 315, each comprising the unique user identifier for the user associated with the event. Data storage 230 may further be configured, in this example, to store one or more calendar event detail data records 325, each comprising a unique calendar event detail identifier for the calendar event detail data record 325. Each calendar event detail data record 325 may also be joined, possibly via a foreign key in the data records, to one or more calendar event data records 320, each calendar event detail data record 325 comprising the unique identifier for the calendar event associated with the event details.

As a non-limiting example, a user account data record 315 may comprise a unique user identifier for a user of the electronic calendar 300 and/or workspace software. One or more calendar event data records 320 may be joined, possibly via a foreign key in the data records, to this user account data record 315. Likewise, one or more calendar event data records 320 may be joined, possibly via a foreign key in the data records, to one or more “potential attendee” or “invitee” user data records for each of the users that the user invites to the calendar event. Each calendar event data record 320 may also comprise a unique calendar event identifier, and any calendar event detail data records 325 may be joined, possibly via a foreign key in the data records, to an appropriate calendar event data record 320.

One or more details about the calendar event may be stored in the database 230, possibly in one or more calendar event detail data records 325. The details about the calendar event may include any stored information relating to the electronic calendar event as described herein, including, but not limited to: a title of the calendar event; a location of the calendar event; a start date and/or start time for the calendar event; an end date and/or end time for the calendar event; a time zone for the start and/or end time for the calendar event; data indicating a selection by the user whether the calendar event comprises an all day event; data indicating a selection by the user whether the event attendees are enabled to invite other attendees to the calendar event; a calendar and/or event type (e.g., personal, professional) associated with the calendar event; an icon associated with the calendar event; the user's attendance (e.g., attending, not attending, tentative) at the calendar event; the completion status (e.g., complete, not complete) of the calendar event; the owner/organizer of the calendar event (possibly associated in the database with a user account data record 310 and/or contact information, such as an email address); one or more contacts (possibly associated in the database with a user account record and/or contact information, such as an email address) to send notifications, if desired, indicating an updated status (attending, not attending, tentative, etc.) for each of the “invitees” of the calendar event; one or more invitees/attendees of the calendar event (possibly associated in the database with one or more user account records and/or contact information, such as an email address); a required status of the one or more invitees/attendees; one or more recurrences of the calendar event and the interval at which the recurrences will occur; one or more reminders of the calendar event to be sent to the user via their stored contact information; and one or more attachments stored in data storage 230 and associated with the calendar event.

The electronic calendar module(s) 305 may be configured, after authenticating and identifying the user, to query the database 230 for one or more calendar event data records 320 associated in the database 230 with the user. In embodiments where the details about each calendar event are stored in one or more calendar event detail data records 325, the electronic calendar module(s) 305 may be further configured to query the database 230 for the calendar event detail data records 325 associated with each calendar event.

The electronic calendar module(s) 305 may be configured to identify the details of each calendar event by identifying and extracting the appropriate data from the data records. Continuing the non-limiting example above, the electronic calendar module(s) 305 may be configured, after querying the database 230 and receiving one or more calendar events and all associated details, to identify and extract the title and start date and/or time for each event from the appropriate data records returned as a query result. For each calendar event returned in the query result, the electronic calendar module(s) 305 may be configured to generate the calendar event, possibly as an image, text, highlighted date and/or time slot, etc. within the generated and/or displayed day/time slot for the calendar event in the electronic calendar 300.

In some embodiments disclosed herein, the electronic calendar module(s) 305 may be configured, after authentication, to receive requests from the client(s) 220 for individual database 230 queries to select specific detail data from the database for a specific event, thereby creating more server 210 involvement for each specific detail data requested. In other embodiments disclosed herein, an initial query may identify, extract and include all detail data for each calendar event associated with the authenticated user. The electronic calendar module(s) 305 may then generate the user interface and transmit it, along with all detail data for each included calendar event, to the client(s) 220, thereby transferring all interaction to client side transactions.

The electronic calendar module(s) 305 may be configured to transmit the generated electronic calendar 300 user interface to the client(s) 220 and may be further configured to receive from the user a request to create a new calendar event, possibly via a link or button to create such an event on the generated calendar user interface, or via a selection by the user of a specific date and/or time on the generated electronic calendar 300 user interface. Alternatively, the electronic calendar 300 user interface may be configured to receive a selection of an individual calendar event for editing/updating, possibly via a selection of an event generated on the electronic calendar 300 user interface.

In response to receiving the request to create a new calendar event, the electronic calendar module(s) 305 may be configured to generate a calendar event control panel 310 for the selected calendar event, such as that shown in FIGS. 4, 6 and 9-15. For requests to edit/update an existing calendar event, the electronic calendar module(s) 305 may be configured, prior to generating the calendar event control panel 310, to query the database 230 for the event details associated in the database 230 with the calendar event data record(s) 320. The electronic calendar module(s) 305 may then generate the calendar event control panel 310 where the appropriate user interface elements are populated with the correct calendar event details. As non-limiting examples, the electronic calendar module(s) 305 may generate the calendar event control panel 310 with the Title and Location text boxes pre-filled with the title and location of the event.

The generated control panel 310, such as that seen in FIGS. 4, 6-7 and 9-15 may be transmitted to, and displayed on, the client(s) 220. All interface elements shown and described, as well as the methods for generating, transmitting and displaying them, should not limit the scope of the invention. As a non-limiting example, as seen in FIGS. 4, 6 and 9-15, the control panel 310 may include user interface elements comprising: a start date interface element, such as a text box and/or a calendar date selection interface element, configured to receive from the user a start date for the event; a start time interface element, such as a text box and/or drop down interface element (divided into 30 minute increments as a non-limiting example) and configured to receive from the user a start time for the event; an end date interface element, such as a text box and/or date selection interface element, configured to receive from the user an end date for the event; an end time interface element, such as a text box and/or drop down interface element (divided into 30 minute increments as a non-limiting example) configured to receive from the user an end time for the event; a time zone interface element, such as a drop down interface element including major U.S. time zones and the ability to configure additional time zones, configured to receive from the user a time zone for the event; an all day event interface element, such as a checkbox, configured to receive from the user a selection indicating the event will include the entire scheduled day (in some embodiments, the start time and end time interface elements may be configured to automatically display 12:00 AM and 11:59 PM respectively if this element is selected); and an “Allow Attendees to Invite Others” interface element, such as a checkbox, configured to receive from the user a selection indicating that other attendees/invitees may invite additional attendees to the calendar event.

As seen in FIGS. 4, 6 and 9-15, for created calendar events, the day of the week selected for start date and end date, as well as the duration of the event may be generated and displayed. For example, as the various interface elements, such as the start date/time and end date/time are selected, logic within the electronic calendar module(s) 305 and/or the generated and displayed control panel 310 may be configured to determine the day of the week and/or the duration of the event and display the results (e.g., “Sunday (30 minutes)”).

The generated control panel 310 interface may further comprise a save button and a cancel button. In the embodiments disclosed herein, if the user selects the cancel button, the control panel 310 may be closed and the data input by the user may be deleted. However, if the user selects the save button, all information from the control panel 310 may be transmitted to the server(s) 220. The electronic calendar module(s) 305 may be configured to receive the data transmitted from the control panel 310 and identify a calendar event data record 320 and/or one or more calendar event details data records 325 for the calendar event. If such a calendar event data record 320 and/or calendar event details data record(s) 325 are identified for the user, the electronic calendar module(s) 305 may be configured to update the data for these data records to reflect the received data. If no calendar event data record 320 and/or calendar event details data record(s) 325 are found in the database for the calendar event, the electronic calendar module(s) 305 may be configured to create a calendar event data record 320, as well as any necessary calendar event detail data records 325, to reflect the received data.

As seen in FIGS. 4, 6-7 and 9-15, the control panel 310 may comprise one or more tabs configured to receive additional calendar event data, which may be received and transmitted to the server(s) 210 for database 230 insertion and/or update. As a non-limiting example, these tabs may include tabs for Details, Attendees & Resources, Recurrence, Reminders, and Attachments associated with the calendar event. As seen in FIG. 4, the Details tab may include user interface elements comprising: a calendar event title interface element, such as a text box, configured to receive from the user a title for the calendar event; a calendar event location interface element, such as a text box, configured to receive from the user a location for the calendar event; a calendar event description interface element, such as a text area, configured to receive from the user a description and/or any additional details for the calendar event; one or more calendar selection interface elements, such as drop down interface elements, configured to receive from the user a selection of a calendar and/or an event type identifying the calendar (e.g., personal calendar, professional calendar) to be associated with the calendar event; an event icon interface element, such as a drop down interface element, configured to receive from the user an icon representing the type of event (e.g., meeting, appointment, personal, holiday, class, doctor, birthday, anniversary, travel, clock, happy hour, celebration, food, heart, baby, pets, activity, sports, phone, present, star, vacation, etc.); an attendance status interface element (e.g., “My Attendance”), such as a drop down interface element, configured to receive from the user a selection identifying the attendance of the authenticated user (e.g., attending, tentative, not attending); an event completion status interface element, such as a drop down interface element, configured to receive from the user a selection identifying whether the event is complete or not complete; an event owner interface element, such as a drop down interface element, configured to receive from the user a selection identifying the “manager” of the event; and an event notification interface element (e.g., “Send Attendance Notifications To”), such as a drop down interface element, configured to receive from the user a selection identifying a user (possibly associated with a user account data record and/or contact information, such as email or SMS messaging), to which to send notifications of the attendance status of event invitees (discussed below).

Methods and Systems for Transmitting Messages to Calendar Event Attendees

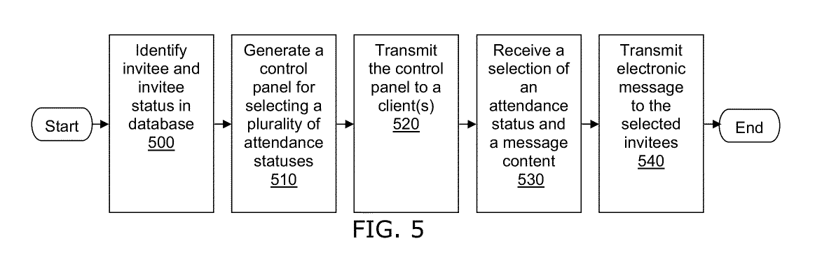

Several different methods may be used to provide and manage the disclosed inventions. In an example embodiment illustrated in FIG. 5, any combination of software modules running on one or more server computers 210 may: identify, within a database 230, at least one invitee associated in the database 230 with the calendar event and the attendance status of the at least one invitee (Step 500); generate a control panel 330 comprising a presentation display of a plurality of attendance statuses, including the attendance status of the at least one invitee, the presentation display being configured for a user to select the attendance status of the at least one invitee from the presentation display (Step 510); transmit the control panel 330 to a client computer 220 (Step 520); receive a selection, from the presentation display, of the attendance status of the at least one invitee and a message content for the electronic message (Step 530); and transmit the electronic message, comprising the electronic message content, to the at least one invitee (Step 540).

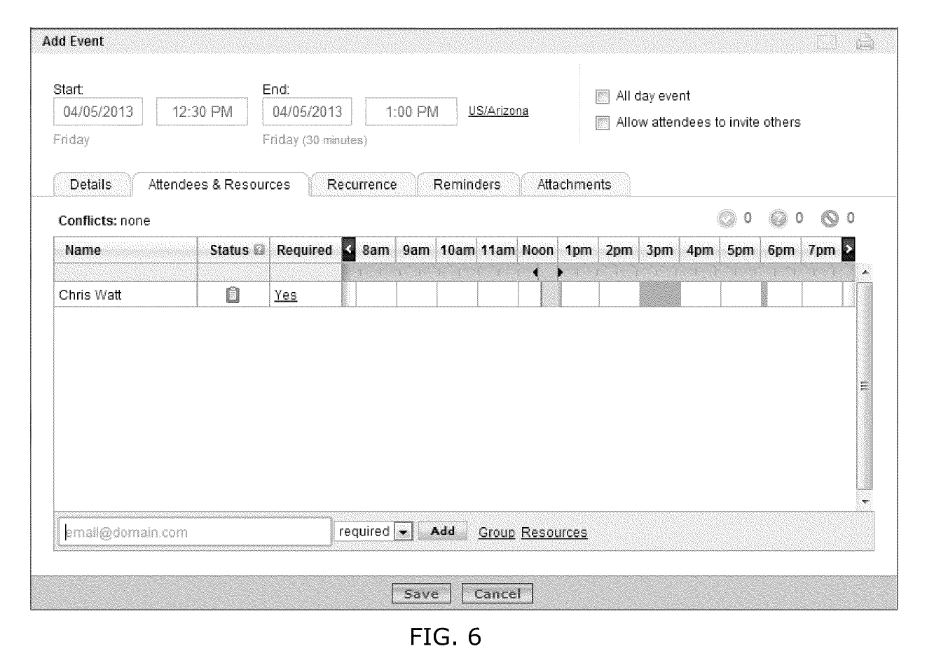

As seen in FIG. 6, the Attendees & Resources tab may include user interface elements comprising an invitee/attendee contact interface element. As a non-limiting example, FIG. 6 shows a text box configured to receive from the user an email address of a potential attendee (invitee) to the calendar event. However, any contact information stored in data storage 230 and associated with one or more user account data records 315 may be used to invite one or more invitees to the calendar event being created/edited by the user currently authenticated to the calendar event control panel 310.

In some embodiments, such as that seen in FIG. 6, the control panel 310 may display and receive input from additional interface elements in the interest of detail and efficiency. As non-limiting examples, the control panel 310 may be configured to receive from the user a selection of a pre-selected group of invitees, and each of these invitees may be sent an invitation to the calendar event, and/or displayed with their attendance status within the Attendees and Resources tab as described below. The control panel 310 may be configured to receive from the user a selection of one or more resources such as reserving a conference room or a conference call dedicated phone line. The control panel 310 may also be configured to receive a selection from the user, such as by the displayed dropdown, whether the selected invitee is required or is optional for the created calendar event.

The control panel 310 may be configured to receive the contact information for the invitee(s), as well as the start day/time and end day/time selected for the calendar event, and transmit this data to the server(s) 210, possibly in response to the user selecting the “Add” button shown in FIG. 6. The electronic calendar module(s) 305 may be configured to receive the calendar event duration and the transmitted contact information, either for an individual invitee or for a group of invitees. For each contact information for each invitee, the electronic calendar module(s) 305 may be configured to query the data storage 230 for a user account data record 315 in the data storage 230 associated with that contact information. If a query response to the data storage 230 query does not comprise at least one record, the electronic calendar module(s) 305 may determine that the selected potential attendee is not a user of the electronic calendar module(s) 305 and therefore no additional information for that user is available for display on the control panel 310. Data indicating that the invitee is not an electronic calendar user may be generated and transmitted to the client(s) 220 for display on the control panel 310.

However, if a user account data record 315 is returned as part of the query response, the electronic calendar module(s) 305 may be configured to identify a name associated with the data record and query the data storage 230 for all calendar event data records, which could potentially conflict with the start and end dates/times for the calendar event inviting the invitees to the event, and associated with that user account data record 315. For each of the returned calendar event data records 320 for each of the invitees, the electronic calendar module(s) 305 may be configured to identify the start and end times for the event for the potential attendee, as well as any potential conflicts with the selected start and end times for the created event (i.e., overlapping event duration between start and end times of one or more scheduled calendar events), and generate and transmit this data to the client(s) 220 for display on the control panel 310.

As seen in the non-limiting example embodiments seen in FIG. 6, the Attendees & Resources tab may be configured to display: the start and end times of the created event comprising the start and end times selected from the control panel 310; the organizer of the event comprising the organizer selected, possibly from the Details tab, from the control panel 310; an icon or other display indicating the organizer of the calendar event; each of one or more scheduled calendar events for the organizer, including any calendar events conflicting with the created event as previously described; and a tally of all scheduled calendar events conflicting with the created calendar event. For each entered invitee not found in data storage 230, the control panel 310 may be configured to display the contact information entered by the user along with an indication that the selected user is not an electronic calendar 320 user. For each entered invitee identified by a user account data record 310 in data storage 230, the control panel may be configured to display the name of the user according to the name identified in the user account data record 315 from data storage 230, and each event and/or potential conflict with the instant event received from the electronic calendar module(s) 305. An attendance status for each invitee may also be displayed. However, until a response is received from each of the invitees (described herein), the status of the potential attendee may remain “unknown” or “not responded.”

The control panel 310 may be configured to save the selected invitees and resources. On receiving a “Save” command as described above, the control panel 310 may be configured to transmit all selected data to the electronic calendar module(s) 305, which may be configured to receive and save to data storage 230 all selected data transmitted from the control panel 310. The server(s) 210 may comprise one or more email or other electronic message servers configured to send email, text, SMS or other electronic messages. On receipt of the transmitted data from the control panel 310, the electronic calendar module(s) 305 may be configured to generate a calendar event invitation (possibly in iCalendar or vCalendar format, as described herein) to each of the invitees, using the contact information provided by the calendar event creator. The calendar event invitation may include the details of the calendar event and one or more user interface elements (e.g., link, button, dropdown, etc.) configured for the invitee to accept, tentatively accept or decline, as non-limiting examples, the electronic calendar invitation.

The electronic calendar module(s) 305 may be further configured to receive the selection by the invitee to accept, tentatively accept or decline the calendar event invitation and store, within data storage 230, this response data as an attendance status for that invitee for that calendar event. As long as no response is received from a potential attendee, the status for that potential attendee may be stored as having not responded yet. Thus, the attendance status for each potential attendee may be stored in data storage 230 as a calendar event detail, and/or may be generated and displayed on the control panel as seen in FIG. 6, possibly as text and/or an icon indicating the attendance status of each invitee. Additionally, FIG. 6 also shows that a running total of each type of attendance status (attending, tentatively attending, not attending), may be tallied and displayed on the control panel 310.

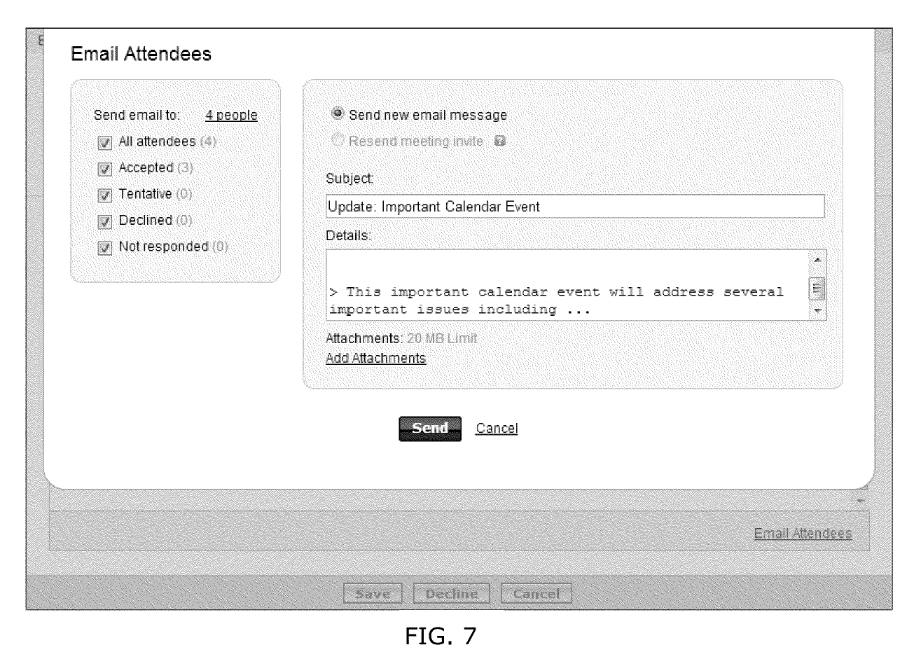

The control panel 310 may comprise an interface element to transmit an electronic message to invitees, such as the “Email Attendees” link displayed in FIG. 7. In response to a selection of this interface element, the control panel 310 may be configured to display the illustrated “pop in” window configured to display the user input elements to send an electronic message the invitees of the created calendar event. In client-side embodiments, one or more software modules on the client computer 220 may be configured generate the pop in window, and to identify and import any necessary data from anywhere within the other user interface elements of the control panel 310 in order to populate and generate the pop in window. The client-server paradigm should not limit the scope of the current invention. Any combination of client 220 and server 210 side features may be used to accomplish any of the method steps disclosed herein.

In server side embodiments, the electronic calendar module(s) 305 may be configured to receive the request for the pop in window. Responsive to this request, the electronic calendar module(s) 305 may be configured to query data storage 230 to identify, possibly via a foreign key in the data records, and select all invitees associated with the created calendar event. For each invitee returned within a query result from the query, the electronic calendar module(s) 305 may be configured to identify the name, contact information and attendance status for that invitee.

The electronic calendar module(s) 305 (and/or any analogous client side software) may then be configured to generate the pop in window for the control panel 310 by generating a presentation display, such as the illustrated list, of a plurality of invitee attendance statuses, each entry in the presentation display comprising an attendance status (e.g., Accepted, Tentative, Declined, Not responded). Each of these entries of attendance statuses may be configured to receive from a user a selection of that attendance status. In the non-limiting example embodiment in FIG. 7, the user may select the list entry for the user status via a check box. FIG. 7 demonstrates that in some embodiments, an additional list entry configured to be selected by the user may comprise an “All attendees” option to select all of the entries for user status. The pop in window may be generated so that the “All attendees” interface element is automatically de-selected if any of the other statuses are deselected, or automatically selected if all other statuses are selected.

As each attendance status for each invitee is identified, that attendance status may be added to a tally of total attendance statuses of that type for the created calendar event. In other words, as the pop in window on the control panel is generated, the total number of invitees with a particular attendance status may be associated with the list entry for that particular attendance status. As each potential attendee status interface element is selected or deselected, the control panel may be configured to add or subtract, respectively, the number of invitees associated with the selected attendance status and this number of invitees may be added to an overall total of all selected invitees. This overall total of selected invitees may be generated and displayed as a “total selected” user interface element (e.g., text, link, button, dropdown, pop in window, etc.) configured to display, when activated, a list of “selected recipients” for a resent calendar event invite or email, as described below. When this “selected recipients” interface element is selected, the pop in window may display the “total selected” list of each of the selected invitees and an indicator (possibly an icon as seen in FIG. 6) of each invitee's attendance status.

As seen in FIG. 7, the pop in window may comprise a “message type” user interface element configured to receive a selection from the user to either resend the calendar event invitation or to send a new electronic message (e.g., email, SMS, text, instant message, etc.) for an update to, or including additional information about, the calendar event invitation. If the user selects the option to resend the calendar event invitation and selects the Send button, the control panel 310 may be configured to transmit the request to resend the calendar event invitation, as well as the list of selected recipients, to the electronic calendar module(s) 305. The electronic calendar module(s) 305 may then be configured to receive the request and the list of selected recipients and resend the calendar event invitation to each of the selected recipients according to the steps to send the calendar event invitation disclosed herein.

If the user selects the option to send a new electronic message to the selected recipients, the control panel may be configured to enable additional user interface elements for sending an email to all selected recipients. These additional interface elements may comprise a subject interface element configured to receive the subject of the electronic message and a message body user interface element configured to receive the body of the electronic message.

In some client-side embodiments, the control panel and/or client-side software may be configured to auto-populate the subject user interface element with the content from the calendar event title user interface element, and the message body user interface element with the event description user interface element (possibly displayed within the “Details” tab as seen in FIG. 4).

In some server-side embodiments, prior to generating the pop in window, the electronic calendar module(s) 305 may be configured to query the database for the selected calendar event and one or more calendar event details. The electronic calendar module(s) 305 may then identify, within a calendar event record (and/or any related calendar event detail records) returned from the database query, the calendar event title and the calendar event description for the calendar event. The electronic calendar module(s) 305 may then generate the pop in window with the message subject and message details user interface elements populated with the calendar event title and the calendar event description respectively.

The user may use the control panel to edit any of the pre-populated fields, add any additional content and select one or more attachments for the electronic message, if desired. The user may select a user interface element to send the electronic message (e.g., the “Send” button in FIG. 7) and the data from the control panel may be transmitted to the electronic calendar module(s) 305. The electronic calendar module(s) 305 may then be configured to receive the data from the control panel 310 and transmit an email to each of the selected recipients.

Methods and Systems for Generating and Displaying a Calendar Event Preview

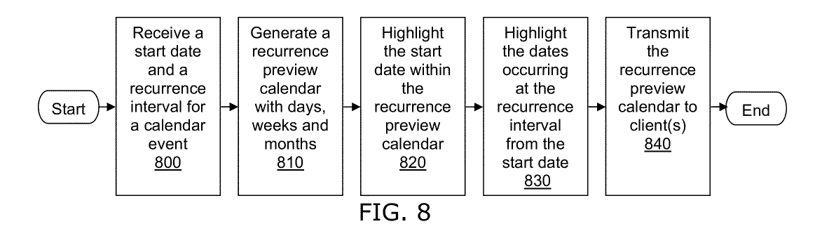

Several different methods may be used to provide and manage the disclosed inventions. In an example embodiment illustrated in FIG. 8, any combination of software modules running on one or more server computers 210 may: receive a start date and a recurrence interval for an electronic calendar event (Step 800); generate a recurrence preview calendar comprising a graphical representation of a plurality of dates arranged to represent days and weeks within at least one month (Step 810); highlight, within the recurrence preview calendar, the start date (Step 820) and at least one of the plurality of dates after the start date occurring at the recurrence interval (Step 830); and transmit the recurrence preview calendar to a client computer (Step 840).

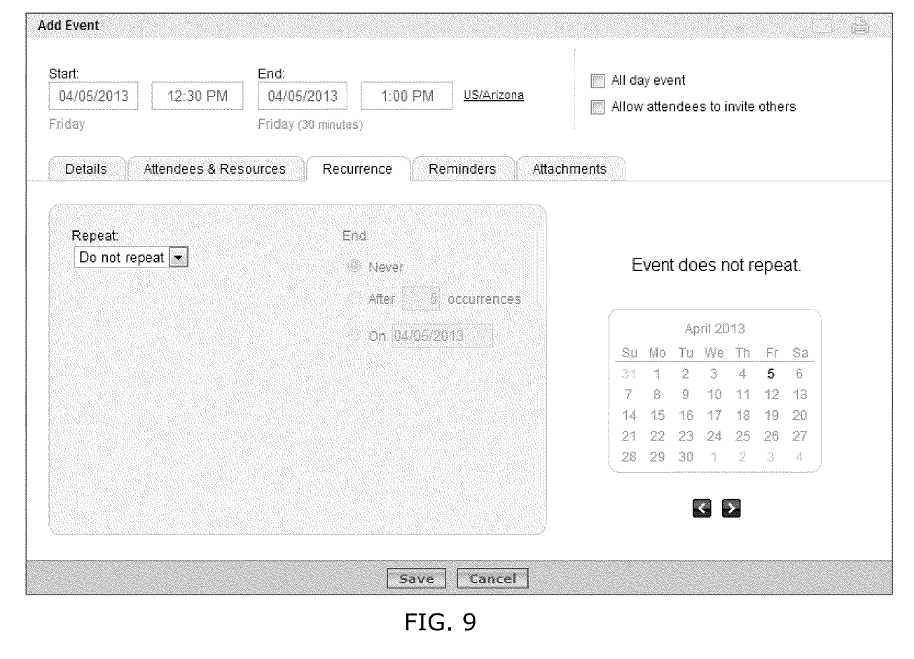

As seen in FIGS. 9-13, the Recurrence tab may include a recurrence definition area, comprising one or more user interface elements for selecting options to define a recurrence of a calendar event, and a recurrence preview area configured to display: a recurrence summary of the selections from the user interface elements in the recurrence definition area; and a recurrence preview calendar configured to display, on a generated calendar, a visual representation of the selections from the user interface elements in the recurrence definition area.

As any option from the user interface elements is changed within the recurrence definition area, the recurrence summary and recurrence preview calendar within the recurrence preview area may be updated to reflect the selected and changed information from the recurrence definition area. In client-side embodiments, client side software and/or scripts may be configured to detect the change in the recurrence definition selection area, update the summary, and generate the recurrence preview calendar in a manner analogous to the server-side embodiments described in detail herein. However, in client-side embodiments, the client side software and/or scripts may use the data from the options selected within the control panel 310 rather than pulling the data from data storage 230.

In server-side embodiments, as any option is changed within the recurrence definition area, data from the control panel 310 may be transmitted to the electronic calendar module(s) 305. The electronic calendar module(s) 305 may be configured to receive this data, which may include the selected start date for the calendar event, and, from the recurrence definition selection area, the selected interval for the recurrence of the calendar event. If selected, the received data may also include an end date or number of occurrences for the recurrence. The electronic calendar module(s) 305 may comprise logic to analyze the received data to determine the recurrence of the event.

The electronic calendar module(s) 305 may then be configured to generate the recurrence summary, comprising text and/or other content describing the interval at which the recurrence will occur, and when the recurrence will end, if applicable. This recurrence summary may be transmitted to the client(s) 220 for display. In some embodiments, such as that seen in FIG. 9-13, the recurrence interval, when generated, as well as any end date, if applicable, may be highlighted or bolded in the recurrence summary content.

The electronic calendar module(s) 305 may also generate the recurrence preview calendar. To accomplish this, the electronic calendar module(s) 305 may generate a graphical representation, possibly of text numerals, of a plurality of calendar dates arranged to represent days and weeks within at least one, as seen in FIGS. 9-13, and possibly multiple months of the electronic calendar. The recurrence preview calendar may further comprise navigation elements to navigate between months or groups of months. Selection of these navigation elements may cause the recurrence preview calendar to be generated for that month or group of months, including any recurrences during that month or group of months.

Using the received start date for the calendar event, the electronic calendar module(s) 305 may then highlight the graphical representation of the start date among the plurality of calendar dates generated on the recurrence preview calendar, as seen in FIGS. 9-13. The highlighted graphical representation of dates as described herein (i.e., highlighting the start date, the dates at the recurrence interval and the recurrence end date, if applicable) may be accomplished via any means of highlighting displayed data known in the art. As non-limiting examples, the graphical representation of the dates may be highlighted by assigning a bold font to the text numerals in the electronic calendar representing the plurality of calendar dates. In other embodiments, such as those seen in FIGS. 9-13, cascading style sheets (CSS) may be used to both change the font color or weight of the affected calendar dates, and to highlight the area that these dates are contained within.

To accomplish this, when generating the recurrence preview, each graphical representation of the plurality of calendar dates may comprise a “block” of data, possibly within an individual <div> or <span> tag of the generated recurrence preview area of the control panel 310. As the electronic calendar module(s) 305 determines the start date, recurrence interval and/or the final recurrence, as described herein, they may generate the recurrence preview calendar with the start date, each date “block” found at the recurrence interval, and/or the final recurrence in a different font color and/or weight and with a highlighted “block.”

The logic to analyze the received data may identify the start date as the start date selected within the control panel 310 as seen in FIGS. 9-13. The logic may further identify the recurrence interval as the data selected and entered from the “Repeat:” user interface element (e.g., Daily, Weekly Monthly, Yearly) and the “Repeat every . . . ” user interface element (e.g., “Repeat every 5 day(s),” “Repeat every 2 month(s),” “Repeat every 1 year(s),” etc.) as seen in FIGS. 9-13. As described herein, the recurrence interval may also be customizable. The graphical representation of the recurrence may be generated where each graphical representation of the date at the recurrence interval from the start date is highlighted according to the highlighting method for the recurrence preview calendar.

As mentioned above and seen in FIGS. 9-13, the recurrence definition selection area may comprise the “Repeat” recurrence interval user interface element, possibly comprising a dropdown for selecting the recurrence interval for the recurrence (e.g., Do not repeat, Daily, Weekly, Monthly, Yearly) and the “Repeat every . . . ” recurrence user interface element possibly comprising a text box to determine how often the selection from the “Repeat” recurrence interval user interface element should occur (e.g., “Repeat every 5 day(s),” “Repeat every 2 month(s),” “Repeat every 1 year(s),” etc.).

In some embodiments, the “Do not repeat” option may be selected by default. Selection of this option may cause all other options within the recurrence definition area, as well as the recurrence preview area to be disabled, as no recurrence selections or previews are necessary. Selections of the other “Repeat” recurrence interval interface elements may trigger updates to the summary and the recurrence preview within the recurrence preview area. Likewise, these selections may cause additional and/or varied user interface elements to be displayed within the recurrence definition area itself, as seen in FIGS. 9-13.

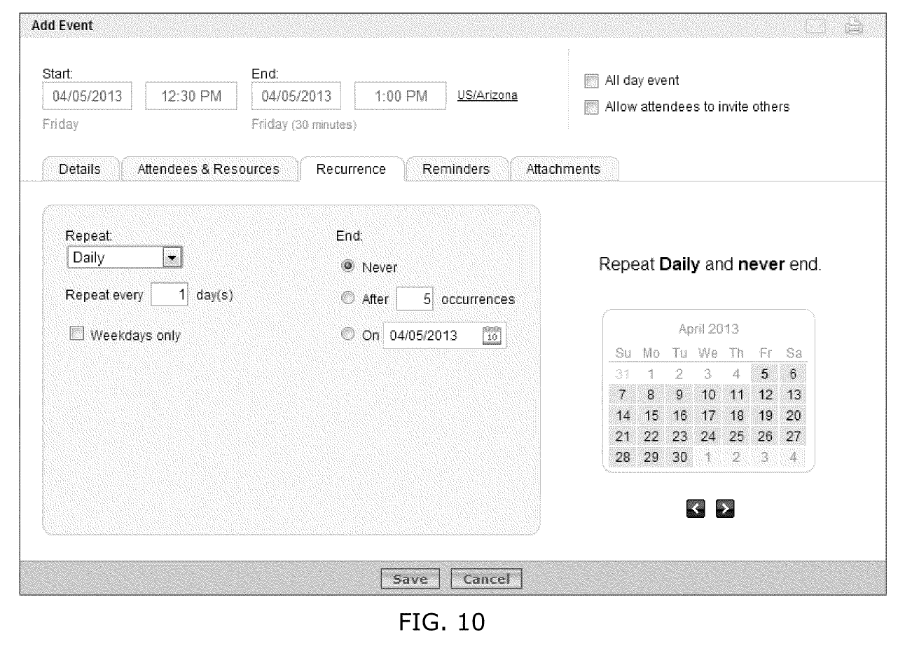

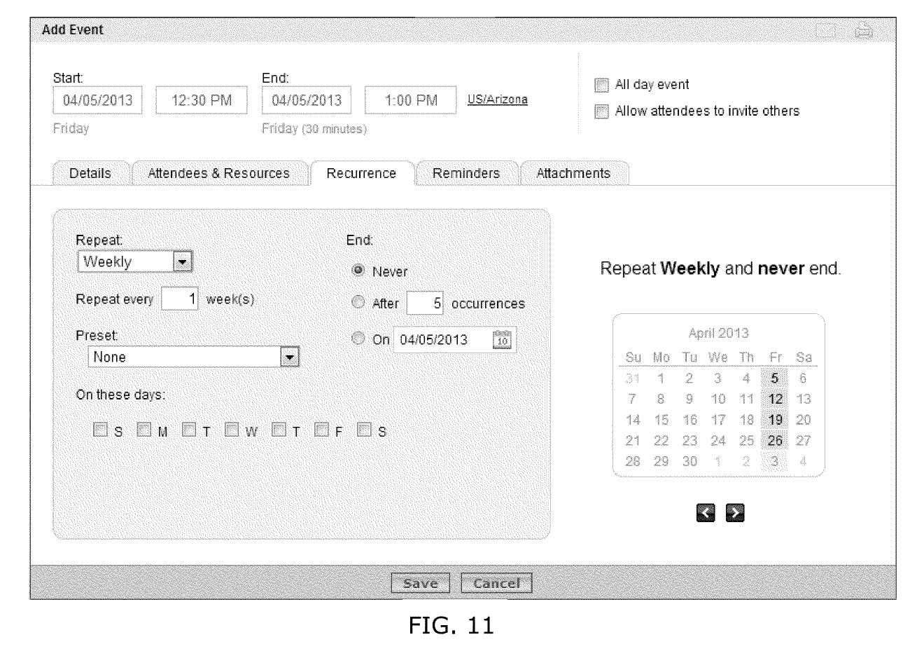

As seen in FIG. 10, selection of “Daily” from the repeat interval user interface element (repeating according to the number entered into the “Repeat every . . . ” user interface element) may cause the recurrence summary to display that the event will “Repeat Daily” (or at the entered interval of days). The recurrence preview calendar may also be generated, updated and/or displayed, as described above, to highlight the start date and each consecutive day, or entered interval of days, on the recurrence preview calendar. Selection of “Daily” from the repeat interval user interface element may also cause the control panel 310 to generate and display, within the recurrence definition area, additional user interface elements, in this case, a checkbox to select only weekdays. Modifications to this user interface element within the recurrence definition area may cause the recurrence summary, as well as the recurrence preview calendar to be generated, updated and/or displayed, as described above, to reflect the daily recurrence as customized in the recurrence definition area.

As seen in FIG. 11, selection of “Weekly” from the repeat interval user interface element (repeating according to the number entered into the “Repeat every . . . ” user interface element) may cause the recurrence summary to display that the event will “Repeat Weekly” (or at the entered interval of weeks). The recurrence preview calendar may also be generated, updated and/or displayed, as described above, to highlight the start date and each consecutive week, or interval of entered weeks, on the recurrence preview calendar. Selection of “Weekly” from the repeat interval user interface element may also cause the control panel 310 to generate and display, within the recurrence definition area, additional user interface elements, in this case, a dropdown comprising “Preset” options (e.g., None; Weekdays (M-F); Monday, Wednesday, Friday; Tuesday & Thursday; Weekend Days) and a selection “On these days:” such as checkboxes for each day of the week as seen in FIG. 11. Modifications to these user interface elements within the recurrence definition area may cause the recurrence summary, as well as the recurrence preview calendar to be generated, updated and/or displayed, as described above, to reflect the weekly recurrence as customized in the recurrence definition area.

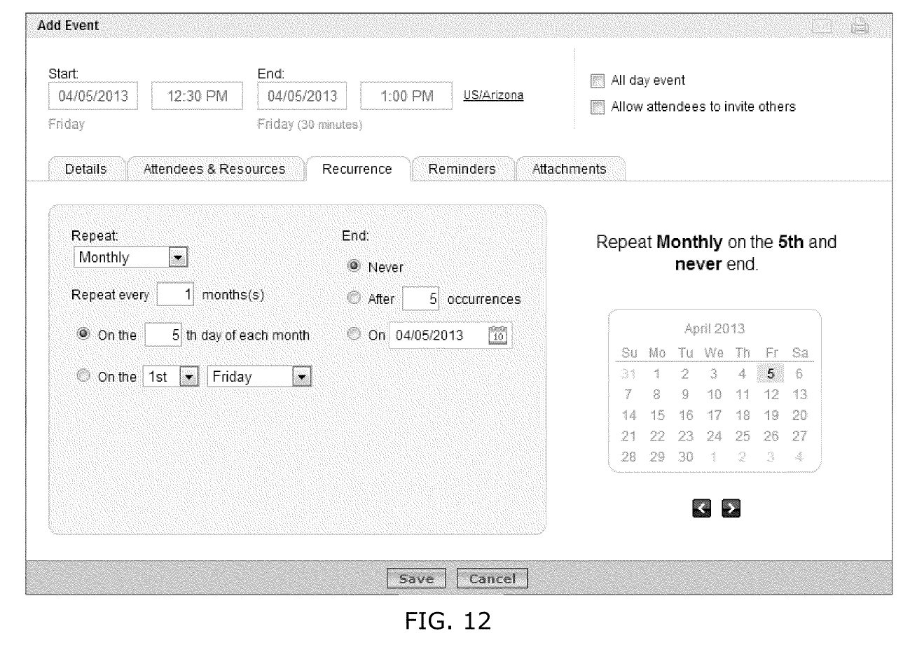

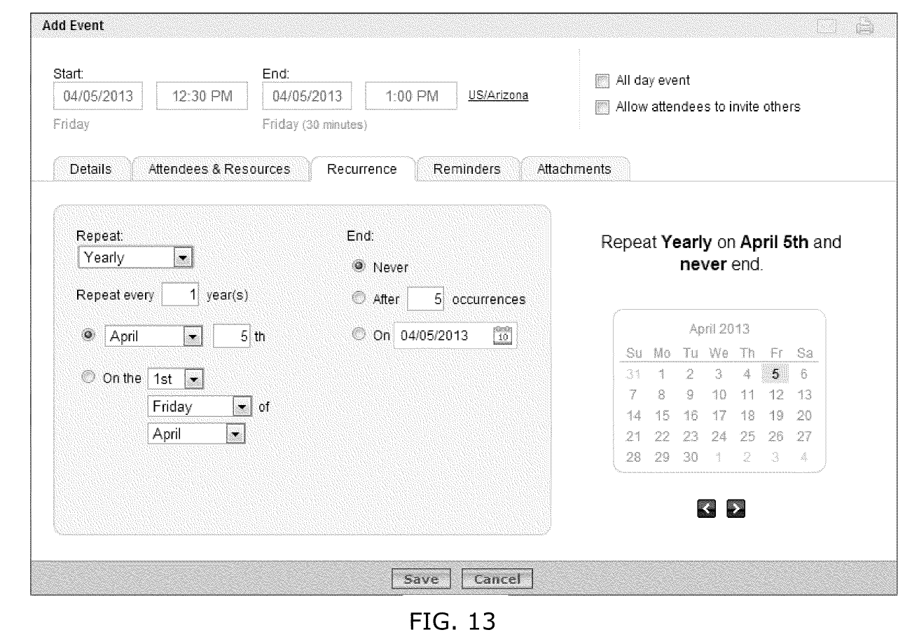

As seen in FIG. 12, selection of “Monthly” from the repeat interval user interface element (repeating according to the number entered into the “Repeat every . . . ” user interface element), may cause the recurrence summary to display that the event will “Repeat Monthly” (or at the entered interval of months) The recurrence preview calendar may also be generated, updated and/or displayed, as described above, to highlight the start date and each consecutive month, or entered interval of months, on the recurrence preview calendar. Selection of “Monthly” from the repeat interval user interface element may also cause the control panel 310 to generate and display, within the recurrence definition area, additional user interface elements, in this case, customizable selections (via text boxes and drop downs) between the entered repetition occurring on a certain day of each month (e.g., “On the 1^{st} day of each month”) or on a certain number of a selected day of the week (e.g. “On the 1^{st} Monday of each month”). Modifications to these user interface elements within the recurrence definition area may cause the recurrence summary, as well as the recurrence preview calendar to be generated, updated and/or displayed, as described above, to reflect the monthly recurrence as customized in the recurrence definition area.

As seen in FIG. 13, selection of “Yearly” from the repeat interval user interface element (repeating according to the number entered into the “Repeat every . . . ” user interface element), may cause the recurrence summary to display that the event will “Repeat Yearly” (or at the entered interval of months) The recurrence preview calendar may also be generated, updated and/or displayed, as described above, to highlight the start date and each consecutive year, or entered interval of years, on the recurrence preview calendar. Selection of “Yearly” from the repeat interval user interface element may also cause the control panel 310 to generate and display, within the recurrence definition area, additional user interface elements, in this case, customizable selections (via text boxes and drop downs) between the entered repetition occurring on a certain date of each year (e.g., “January 1”) or on a certain number of a selected day of the week within a certain month (e.g. “On the 1^{st} Monday of January”). Modifications to these user interface elements within the recurrence definition area may cause the recurrence summary, as well as the recurrence preview calendar to be generated, updated and/or displayed, as described above, to reflect the monthly recurrence as customized in the recurrence definition area.

The recurrence definition area may also comprise a final recurrence user interface element. As seen in FIGS. 9-13, this final recurrence user interface element may comprise a plurality of selectable options for when to end the recurrence. In the non-limiting example seen in FIGS. 9-13, a first selectable option may comprise an option to never end the recurrence. In some embodiments, this may be the default selection when the recurrence tab is selected. A second selectable option may end the recurrence after a selected number of occurrences. The number of occurrences after which to end the recurrence may be entered by a user, possibly via a text box included with the second option as seen in FIGS. 9-13. A third selectable option may end the recurrence on a specific date. To accomplish this, the third selectable option may comprise a calendar date selection user interface element configured to receive a specific date from the user on which to end the recurrence. The server may receive these options and apply them when generating the recurrence summary and recurrence preview. These selection may be generated and/or displayed within the recurrence preview area.

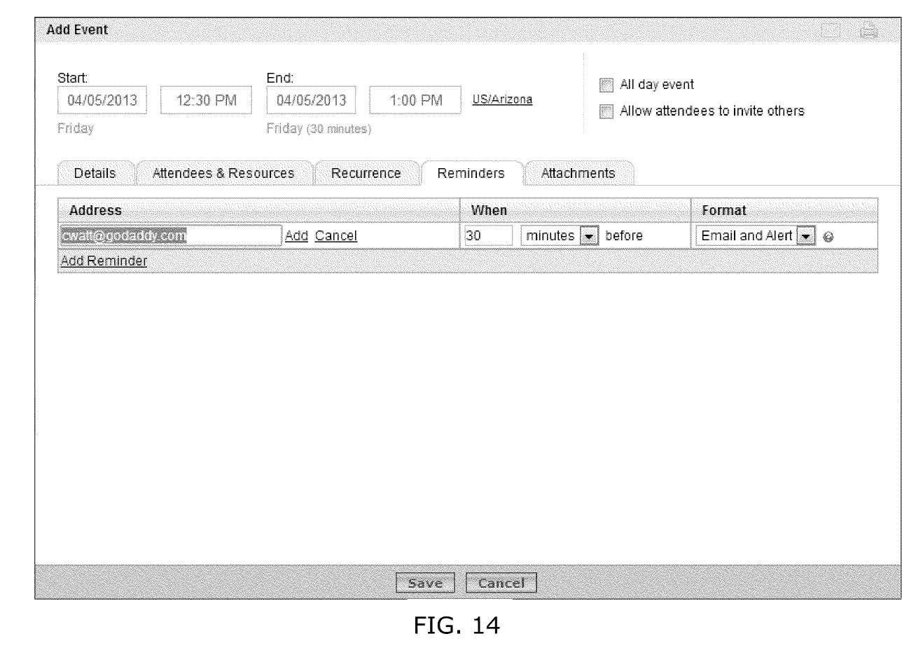

As seen in FIG. 14, the Reminders tab may include a user interface element, such as a link or button, that when selected creates a reminder of the selected event. Selection of the user interface element may cause the content in the reminders tab to display a form for receiving from the user, via user interface elements, one or more email address to send the reminder to; a time interval prior to the calendar event to send the alert to (e.g., a drop down to select time increments (minutes, hours, days, weeks) and a text box to receive the number of increments (“30 minutes”)); and a contact selection user interface element, possibly a drop down including options to send the reminder of the calendar event to (e.g., Email and Alert, SMS and Alert, Email, SMS, Alert). The data from the Reminders tab may be transmitted to the electronic calendar module(s) 305, which may then store the reminder in data storage 230 and send the reminder via the selected contact at the selected time prior to the calendar event.

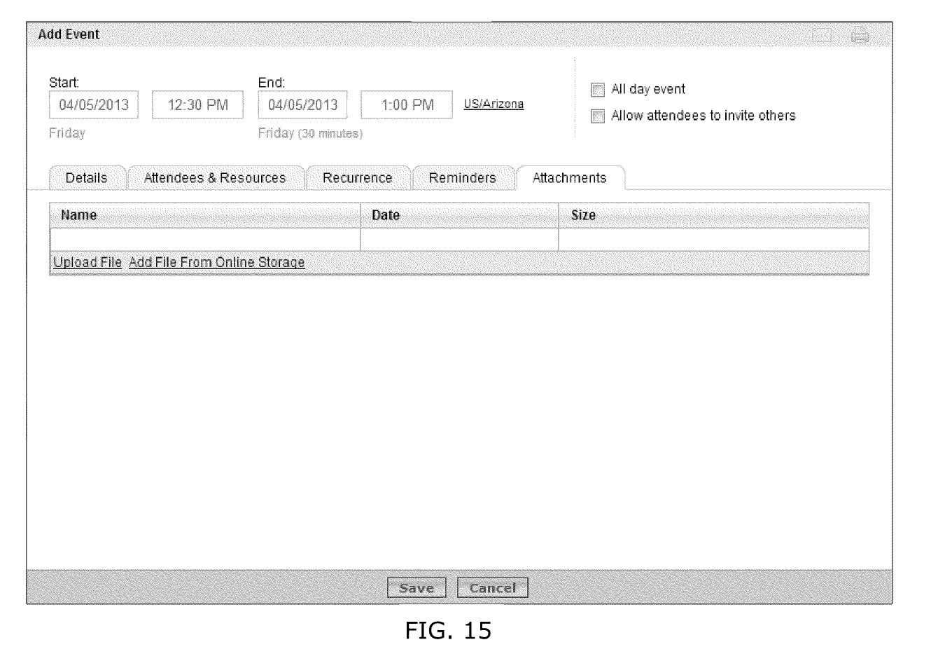

As seen in FIG. 15, the Attachments tab may include a user interface element, such as a link or button to select a file to attach to the electronic calendar event. The selected file may be uploaded and stored in data storage in association with the calendar event. In embodiments where the electronic calendar is part of a workspace suite, the workspace suite may comprise an online storage component. In these embodiments, the attached file may be a file stored in the online storage and associated in the database with the calendar event.

Any steps included in the embodiments illustrated in FIGS. 1-15 are not limited to their respective illustrated embodiments, and may be combined in several different orders and modified within multiple other disclosed embodiments. Likewise, the method steps disclosed herein may be accomplished by a software module executed on a server and/or client configured to accomplish that method step.

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A method of sending an electronic message according to an attendance status of at least one invitee to a calendar event, the method comprising the steps of:
A) identifying, by at least one server computer communicatively coupled to a network, within a database communicatively coupled to the network:
i) the at least one invitee associated in the database with the calendar event; and
ii) an attendance status of the at least one invitee;
B) generating, by the at least one server computer, a control panel comprising a presentation display of a plurality of attendance statuses including the attendance status of the at least one invitee, the presentation display being configured for a user to select the attendance status of the at least one invitee from the presentation display;
C) transmitting, by the at least one server computer, the control panel to a client computer communicatively coupled to the network;
D) receiving, by the at least one server computer:
i) a selection, from the presentation display, of the attendance status of the at least one invitee; and
ii) a message content for the electronic message; and
E) transmitting, by the at least one server computer, the electronic message, comprising the message content, to the at least one invitee according to the attendance status of the at least one invitee.

2. The method of claim 1, wherein the message content comprises:
i) an electronic message subject; and
ii) an electronic message body.

3. The method of claim 2, wherein:
i) a content for the electronic message subject comprises a title of the calendar event; and
ii) a content for the electronic message body comprises a description of, or at least one detail about, the calendar event.

4. The method of claim 1, wherein the electronic message comprises:
i) a repeat invitation to the calendar event; or
ii) an update regarding at least one detail about the calendar event.

5. The method of claim 1, wherein transmitting step E) further comprises the steps of:
i) querying, by the at least one server computer, the database for a contact information for the at least one invitee; and
ii) transmitting, by the at least one server computer, the electronic message to the at least one selected recipient via the contact information.

6. The method of claim 6, further comprising the steps of:
i) receiving, by the at least one server computer, a plurality of calendar event information, comprising the at least one invitee, from the client computer;
ii) generating, by the server computer, a calendar event invitation;
iii) transmitting, by the server computer, the calendar event invitation to the at least one invitee;
iv) receiving, by the server computer, from the at least one invitee, a response to the electronic calendar event invitation;
v) identifying, by the server computer, according to the response received, a status of the at least one invitee;
vi) storing, by the server computer, the status of the at least one invitee in the database; and
vii) transmitting, by the server computer, a status of the at least one invitee for display on the control panel.

7. The method of claim 1, further comprising the steps of:
i) receiving, by the at least one server computer, a contact information for the at least one invitee;
ii) determining, by the server computer, whether the contact information is found in the database;
iii) responsive to a determination that the contact information is not found in the database, generating, by the at least one server computer, a calendar content indicating that the contact information is not associated with a user of the electronic calendar;
iv) responsive to a determination that the contact information is found in the database:
a) identifying, by the at least one server computer, an invitee name for the at least one invitee associated in the database with the contact information;
b) identifying, by the at least one server computer, within the database, at least one calendar event for the at least one invitee;
c) generating, by the at least one server computer, the calendar content comprising:
1) the invitee name; and
2) a start time and an end time for the at least one calendar event; and
v) transmitting, by the at least one server computer, to the client computer, the calendar content.

8. The method of claim 1, further comprising the steps of:
i) receiving, by the at least one server computer, a request to create or edit the calendar event; and
ii) generating, by the at least one server computer, the control panel comprising means to create or edit the calendar event.

9. The method of claim 8, further comprising the steps of:
i) receiving, by the at least one server computer, a plurality of data transmitted from the control panel;
ii) determining, by the at least one server computer, whether at least one calendar event data record in the database comprises the plurality of data;
iii) responsive to a determination that no calendar event data records in the database comprise the plurality of data, creating, by the at least one server computer, a new calendar event data record in the database; and
iv) responsive to a determination that the at least one calendar event data record in the database comprises the plurality of data, updating, by the at least one server computer, the at least one calendar event data record to reflect the received data.

10. A system for sending an electronic message according to an attendance status of at least one invitee to a calendar event, the system comprising at least one electronic calendar module running on at least one server computer communicatively coupled to a network and configured to:
A) identify within a database communicatively coupled to the network:
i) the at least one invitee associated in the database with the calendar event; and
ii) an attendance status of the at least one invitee;
B) generate a control panel comprising a presentation display of a plurality of attendance statuses including the attendance status of the at least one invitee, the presentation display being configured for a user to select the attendance status of the at least one invitee from the presentation display;
C) transmit the control panel to a client computer communicatively coupled to the network;
D) receive:
i) a selection, from the presentation display, of the attendance status of the at least one invitee according to the attendance status of the at least one invitee; and
ii) a message content for the electronic message; and
E) transmit the electronic message, comprising the message content, to the at least one invitee.

11. The system of claim 10, wherein the control panel comprises a message type user interface element configured to receive, from a user, identification of the electronic message as:
i) a repeat invitation to the calendar event; or
ii) an update regarding one or more details about the calendar event.

12. The system of claim 10, wherein the control panel comprises:
i) a first editable text user interface element comprising a content from a title of the calendar event; and
ii) a second editable text user interface element comprising content from a description of, or one or more details about, the calendar event.

13. The system of claim 10, wherein the control panel comprises a user interface element to add an attachment to the electronic message.

14. The system of claim 10, wherein the control panel further comprises a selected recipients user interface element configured to display a list of the at least one invitee and the attendance status of the at least one invitee.

15. The system of claim 14, wherein the selected recipients user interface element groups the at least one attendee according to:
i) an accepted attendance status for the at least one attendee;
ii) a tentative attendance status for the at least one attendee;
iii) a declined attendance status for the at least one attendee; or
iv) a not responded attendance status for the at least one attendee.

16. The system of claim 10, wherein the control panel comprises an attendees and resources tab user interface element configured to receive from the user:
i) a contact information for the at least one invitee;
ii) a selection of whether the at least one invitee is required for the calendar event; and
iii) a request for a resource related to the calendar event.

17. The system of claim 10, wherein the control panel is configured to display:
i) a duration for the calendar event;
ii) a name of the at least one invitee;
iii) an attendance status of the at least one invitee;
iv) a conflicting calendar event occurring during a scheduled time for the calendar event; and
v) a tally of at least one conflicting calendar events;

18. The system of claim 10, wherein the database further comprises:
i) at least one user account data record; and
ii) at least one calendar event data record associated in the database with the at least one user account data record.

19. The system of claim 10, wherein one or more interface elements on the control panel are populated with data from at least one calendar event data record or at least one calendar event detail data record stored in the database.
